(19) United States
(12) Patent Application Publication
(10) Pub. No.: US 2008/0259093 A1
(43) Pub. Date: Oct. 23, 2008

(54) Electronic device and method for displaying a full frame image

(75) Inventor: Wei-Chung Tseng, Taoyuan County (TW)

Correspondence Address: BIRCH STEWART KOLASCH & BIRCH, PO BOX 747, FALLS CHURCH, VA, 22040-0747, US

(73) Assignee: Qisda Corporation, Taoyuan County (TW)

(21) Appl. No.: 12/081,375

(22) Filed: Apr. 15, 2008

(30) Foreign Application Priority Data
Apr. 17, 2007 (TW) 096113528

(51) Int. Cl. G09G 5/00

(52) U.S. Cl. 345/619; 345/1.3

(57) ABSTRACT

An electronic device is proposed for cooperating with a first electronic device to display a full image corresponding to a video signal. The electronic device includes a display screen for displaying a first partial image of the full image. The first electronic device includes a first display screen for displaying a second partial image of the full image. The electronic device further includes a control module for generating an adjust command and a transmitting module for transmitting the adjust command to the first electronic device in order to rotate the second partial image in such a manner that the second partial image combines with the first partial image to match the full image.

### FIELD OF THE INVENTION

The invention relates to an electronic device and a method for displaying a full image, and more particularly to the electronic device for cooperating with two or more electronic devices for displaying the full image corresponding to a video signal and the method for displaying the full image.

### BACKGROUND OF THE INVENTION

It has been for many decades, a display wall within TV sets is used for displaying an image upon receipt of a video signal. In order to achieve a specific or advertising effect, several sets of TV are piled upon or stacked up together so as to form a TV wall or jumbo screen, in which, each TV set displays a partial image and a total of the partial images cooperatively form a full image in accordance with the video signal.

The aforesaid TV wall is bulky in size, is not portable and is neither required to be moved about. The main problem resides in that how to obtain the correct orientation of the partial image in each TV set with respect to the frame of the TV wall for matching the full image during the display process.

The utility of display technology (or mobile telephony) is relatively wide nowadays. It is used in many portable electronic devices, for instance in mobile phones, smartphones, GPS (Global Positioning System) receivers and wireless communication devices, each is provided with a display wall for displaying an image or text message.

Therefore, it is the main object of the present invention is to provide a display method and an electronic device that cooperates with other partial images so as to form a full image in accordance with the video signal, thereby eliminating the problems encountered during use of the prior art portable electronic devices.

### SUMMARY OF THE INVENTION

It is the object of the present invention to provide an electronic device and a method for displaying a full image. The electronic device accordingly cooperates with two or more electronic devices for displaying the full image corresponding to a video signal and the method for displaying the full image.

According to one aspect of the present invention, an electronic device is proposed for cooperating with a first electronic device to display a full image corresponding to a video signal. The first electronic device includes a first display screen. The electronic device in fact is a wireless communication device and includes a display screen, a control module and a transmitting module.

The display screen is used for displaying a first partial image of the full image. The first display screen is used for displaying a second partial image of the full image.

The control module is used for generating an adjust command. The transmitting module is used for transmitting the adjust command to the first electronic device in order to adjust the second partial image in such a manner for example rotating the second partial image, that the second partial image combines with the first partial image to match the full image.

In another aspect of the present invention, an electronic device and display method thereof is provided. By utilizing the control module and the transmitting module, the orientation of the several partial images can be corrected so as to form a full image conforming to the video signal. The specific feature can be applied in portable electronic devices respectively displaying partial images, which cooperatively form the full image.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a schematic view of an electronic device of the present invention;

FIG. 2 illustrates how the electronic device of the present invention selects a video signal from a plurality of channel signals;

FIG. 3 shows a first embodiment, illustrating how an orientation of a partial image is adjusted with respect to the electronic device of the present invention;

FIG. 4 shows a second embodiment, illustrating how an orientation of a partial image is adjusted with respect to the electronic device of the present invention;

FIG. 5 is a schematic view illustrating the orientation adjustment of the first and second embodiments in the electronic device of the present invention;

FIG. 6 shows a third embodiment, illustrating how an orientation of a partial image is adjusted with respect to the electronic device of the present invention;

FIG. 7 shows a fourth embodiment, illustrating how an orientation of a partial image is adjusted with respect to the electronic device of the present invention; and

FIG. 8 is a block diagram illustrating the steps of the method for displaying a full image according to the present invention.

### DETAILED DESCRIPTIONS OF THE PREFERRED EMBODIMENTS

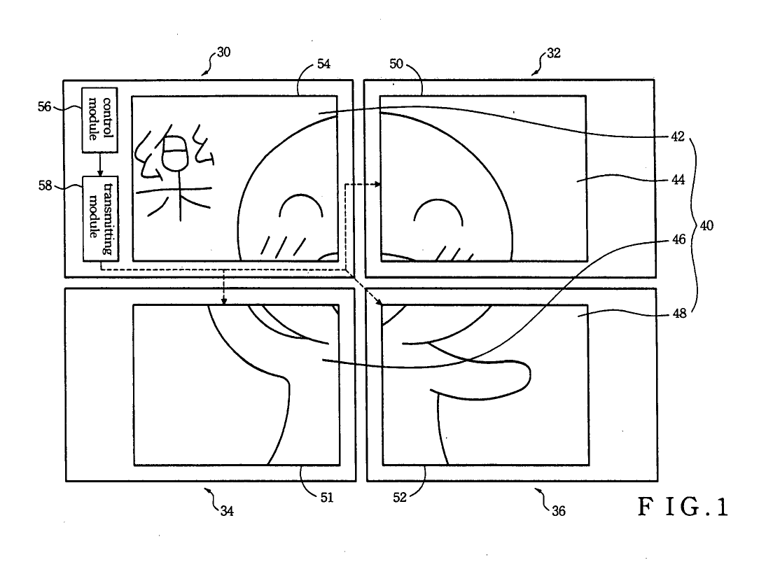

FIG. 1 shows a schematic view of an electronic device 30 of the present invention that cooperates with other electronic devices to display a full image 40 corresponding to a video signal. Herein, the electronic device 30, the first electronic device 32, the second electronic device 34 and the third electronic device 36 are putting together next to each other.

The first electronic device 32 includes a first display screen 50. The second electronic device 34 includes a second display screen 51 while the third electronic device 36 includes a third display screen 52. The electronic device 30 can be a wireless communication device, and includes a display screen 54, a control module 56 and a transmitting module 58.

The display screen 54 is used for displaying a first partial image 42. The first display screen 50 is used for displaying a second partial image 44. The second display screen 51 is used for displaying a third partial image 46. The third display screen 52 is used for displaying a fourth partial image 48.

The control module 56 is capable of generating an adjust command. The transmitting module 58 can be a wireless transmitting module, such as Bluetooth module, WLAN module or ultrared module for transmitting the adjust command to the first electronic device 32, the second electronic device 34 and the third electronic device 36 in order to adjust the second partial image 44, the third partial image 46 and the fourth partial image 48 with respect to the first partial image 42 in such a manner that the second, third and fourth partial images 44, 46, 48 combine with the first partial image 42 to match the full image 40.

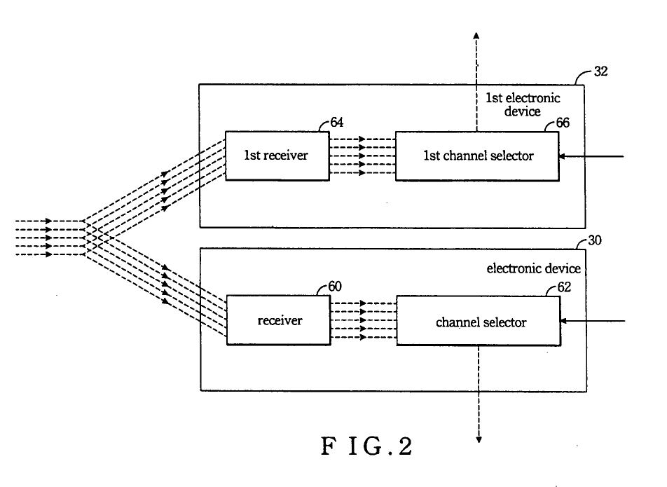

FIG. 2 illustrates how the electronic device 30 of the present invention selects a video signal from a plurality of channel signals. The electronic device 30 further includes a receiver 60 for receiving a plurality of channel signals, and a channel selector 62 is used for selecting the video signal from the plurality of channel signals in accordance with a selection signal in order to display the first partial image 42.

In addition, the first electronic device 32 further includes a first receiver 64 and a first channel selector 66. The first receiver 64 is used for receiving a plurality of channel signals and the first channel selector 66 selects the video signal from the plurality of channel signals in accordance with a selection signal such that the selected video signal is similar to that of the channel selector 62 so as to display the second partial image 44.

Note that the video signal received by the receiver 60 and the first receiver 64, for example, is a DVB (Digital Video Broadcast) standard signal or an analog TV Broadcast signal. The receiver 60 and the first receiver 64 are capable of modulating a high channel signal into a low channel signal in order to enable the channel selector to select the desired channel signal. In the same manner, the second and third electronic devices 34, 36 are capable of selecting the same video from the plurality of channel signals in accordance with a selection signal so as to display the respective partial image, and eventually combine together to form the full image 40.

When the aforesaid receivers and the channel selectors are mounted respectively in the electronic device 30, the first electronic device 32, the second electronic device 34 and the third electronic device 36, the adjust command generated by the control module 56 is transmitted to other electronic devices and capable of controlling the aforesaid electronic devices such that the channel selectors thereof select the video signal from the same channel so as to activate the partial images. In case, a channel selection command, a channel change command or a channel number is inputted directly into the interface (not shown) of the electronic device 30, the adjust command will be transmitted respectively to the first, second and third electronic devices 32, 34, 36 such that the three electronic devices will select the channel same as that of the electronic device 30.

In actual application, a Bluetooth short-distance wireless transmitting module is utilized for linking a plurality of the wireless communication devices, such as mobile phones. Each mobile phone is equipped with a receiver that is capable of receiving the DVB-H (Digital Video Broadcast to Handheld) standard signal or DVB-T (Digital Video Broadcast Terrestrial) standard signal. Thus, when the mobile phone (the so-called electronic device) is under the switch-on mode, the display screen of the mobile phone is capable of displaying a full image upon receipt of the DVB-H standard signal. A software is utilized for setting an individual ID address for each of the electronic devices. The Bluetooth wireless transmitting module is activated in order to enable the electronic devices to receive the DVB-H standard signal or DVB-T standard simultaneously, thereby accomplishing the formation of full image.

The DVB-H standard has a low signal resolution when compared to that of the DVB-T standard so that in case of receiving the DVB-H standard signal, a great amplifying process is required in order to conform with the pixel resolution of the mobile phone. In case of receiving the DVB-T standard signal, an amplifying or de-amplifying process is required to be conducted in the electronic devices in order to form the full image 40.

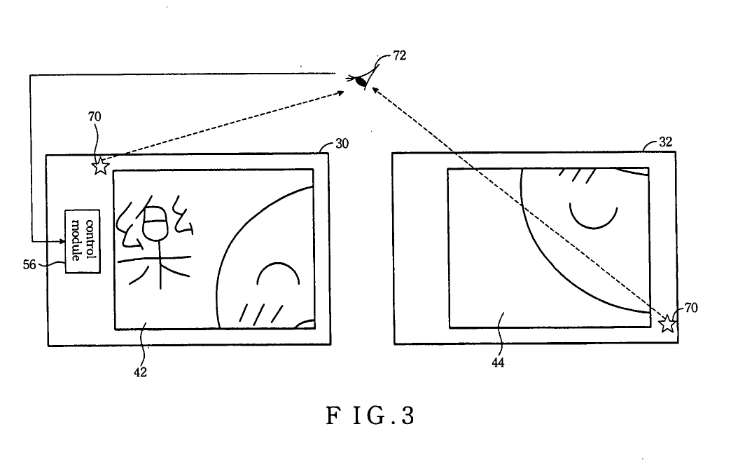

Several methods can be implemented for automatically adjusting the orientation of the partial image. FIG. 3 shows a first embodiment, illustrating how an orientation of the partial image is adjusted with respect to the electronic device of the present invention. The operator 72 uses a directional symbol 70 so as to enable the control module 56 to generate the adjust command. The directional symbol 70 is printed on an outer surface of the electronic device and by which an extending orientation of the electronic device is determined so as to generate the adjust command.

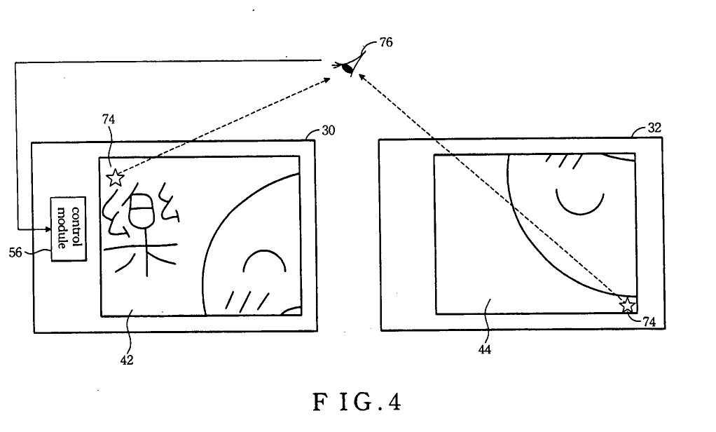

1. FIG. 4 shows a second embodiment, illustrating how an orientation of a partial image is adjusted with respect to the electronic device of the present invention In this embodiment, a first directional symbol 74 is displayed on the display screen of the electronic device 30 at one corner thereof and a second directional symbol 74 is displayed on the first display screen of the first electronic device 32. The operator 76 can uses the directional symbol 70 so as to enable the control module 56 to generate the adjust command to change the orientation of the second partial image 44 (hence the second directional symbol 74) with respect to the first partial image 42 or change the orientation of the first partial image 42 (hence the first directional symbol 74) with respect to the second partial image 44. In other words, the control module generates the adjust command by which an extending orientation of the electronic device is determined.

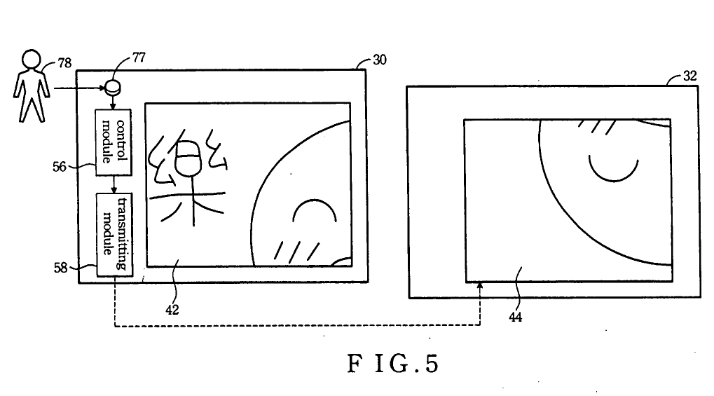

FIG. 5 is a schematic view illustrating the orientation adjustment of the first and second embodiments in the electronic device of the present invention. As illustrated in FIGS. 3 and 4, in the event, the orientation of the partial images in the first and second electronic devices is unable to conform to one another; correction to the orientation thereof is required. In order to accomplish this task, the electronic device 30 or the first electronic device 32 is provided with a touch panel 77 that enables the operator 78 to touch such that the control module 56 generates the adjust command.

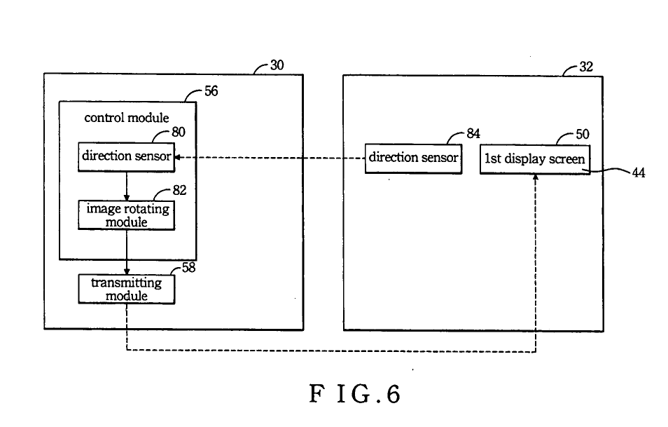

FIG. 6 shows a third embodiment, illustrating how an orientation of a partial image is adjusted with respect to the electronic device of the present invention. The control module 56 of the electronic device 30 further includes a direction sensor 80 and an image rotating module 82. The image rotating module 82 is capable of rotating orientation of the second partial image via the direction sensor 80 after comparing orientation of the first electronic device 32 with respect to the electronic device 30. The image rotating module 82 generates the adjust command transmitted via the transmitting module 58 to the first electronic device 32 for changing the orientation of the first electronic device 32 via the direction sensor 80 after comparing the orientation of the first electronic device 32 with respect to the electronic device 30 and in case the orientation of the second partial image 44 is different to the first partial image 42 such that the first and second partial images 42, 44 cooperatively combine together to match the full image 40. [0034] The aforesaid direction sensor 80, 84 can be a gravitational sensor for sensing the orientation of the electronic device 30 and the other electronic device 32. Alternatively, the direction sensor 80, 84 can be a geomagnetic direction sensor, such as an electrical compass, for determining fining the orientation the electronic device 30 and the other electronic device 32.

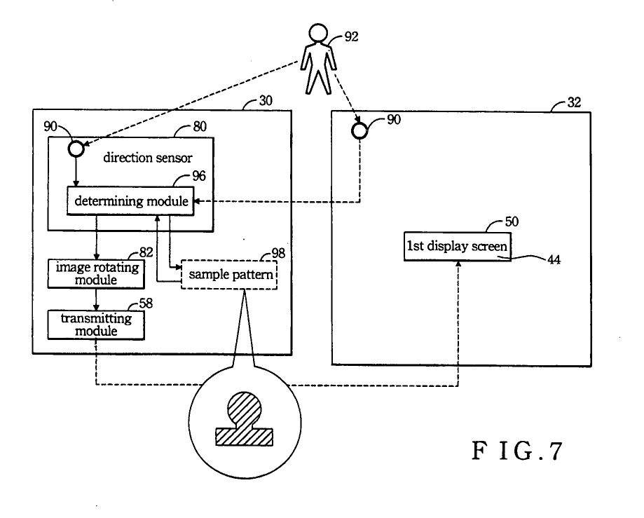

FIG. 7 shows a fourth embodiment, illustrating how an orientation of a partial image is adjusted with respect to the electronic device of the present invention. The direction sensor 80 of the electronic device 30 further includes a photographing device 90 and a determining module 96. Each of the electronic devices is provided with a photographing device 90 for catching a specific pattern after shooting an object 92 (such as a silhouette of a person). The determining module 96 determines the orientation of the electronic device 30 after comparing the specific pattern with a sample pattern 98 stored within the memory device in advance.

The orientation of the electronic device 30 is usually defined or changed only after comparing the specific pattern with the sample pattern 98. Once the orientation of the electronic device is determined, the image rotating module 82 will generate the adjust command via the transmitting module 58 so as correct the orientation of the other electronic device to be compatible with the electronic device 30.

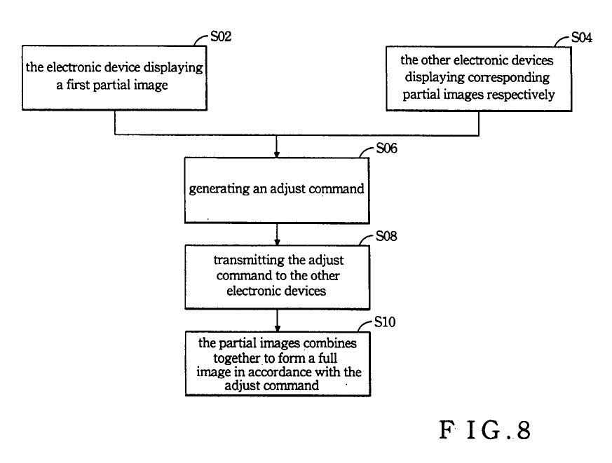

FIG. 8 is a block diagram illustrating the steps of the method for displaying a full image 40 by an electronic device 30 of the present invention cooperating with the first electronic device 32, the second electronic device 34 and the third electronic device 36corresponding to a video signal. The electronic device 30 in fact is a mobile phone. The method comprising the steps:

Step (S02): the electronic device 30 displaying a first partial image 42;

Step (S04): the first electronic device 32 displaying a second partial image 44, the second electronic device 34 displaying a third partial image 46 and the third electronic device 36 displaying a fourth partial image 48, respectively;

Step (S06): generating an adjust command;

Step (S08): transmitting the adjust command to the first, second and third electronic devices 32, 34, 36 via a wireless transmitting module;

Step (S10): the second partial image 44, a third partial image 46 and the fourth partial image 48 are adjusted with respect to the first partial image 42. In the event the orientation of the former electronic devices is not compatible with the electronic device, the former electronic devices are adjusted in such a manner that the second partial image 44, a third partial image 46 and the fourth partial image 48 combine with the first partial image 42 to form the full image 40.

Prior to the Step (S02), the method further includes the steps:

Step (S12): receiving a plurality of channel signals;

Step (S14): selecting the video signal from the plurality of channel signals in accordance with a selection signal.

In addition, the first electronic device 32 includes the following steps:

Step (S16): receiving a plurality channel signals; and

Step (S18): selecting the video signal from the plurality of channel signals the same as that of the electronic device 30. The video signal is a DVB (Digital Video Broadcast) signal.

Several embodiments can be implemented in order to achieve the Step (S06). The electronic device 30 has a directional symbol 70 printed on an outer surface thereof, by which an extending orientation of the electronic device 30 is determined so as to generate the adjust command.

Alternatively, the electronic device 30 may have a display screen which is displayed with a directional symbol 74 and by which the operator 76 can determined an extending orientation of the electronic device 30 so as to generate the adjust command.

Once the orientation of the electronic device 32 is defined and in the event the orientation of the image is not compatible to the full frame, the operator can press the touch panel 77 of the electronic device 30 to generate the adjust command so as to correct the orientation of the partial images in the other electronic devices.

In addition, the display method of the present invention may further includes the following steps. The electronic device 30 further includes a direction sensor 80 for detecting an orientation thereof. In case an orientation of the first electronic device 32 is not compatible with the electronic device 30 after comparing, the adjust command is generated to correct orientation of the second partial image 44 via the direction sensor 80 such that the first and second partial images 42, 44 cooperatively combine together to form the full image 40.

The direction sensor 80 can be is a gravitational sensor or a geomagnetic direction sensor. The direction sensor 80 of the electronic device 30 further includes a photographing device 90 for catching a specific pattern after shooting an object 92 and a determining module 96 for determining the orientation of the electronic device 30 after comparing the specific pattern with a pre-stored sample pattern 98.

By utilizing the control module 56 and the transmitting module 58 of the electronic device 30 of the present invention, and since the orientation of the partial images can be corrected with respect to the frame, a full image 40 can be displayed after correcting the orientation of the partial images corresponding to the video signal. The features and ability of the present invention can be utilized in the TV wall as well as the portable handheld device, like mobile phone, in order to provide the full image.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electronic device for cooperating with a first electronic device to display a full image of a video signal, the first electronic device having a first display screen, the first display screen being used for displaying a second partial image of the full image, the electronic device comprising:
a display screen for displaying a first partial image of the full image;
a control module for generating an adjust command; and
a transmitting module for transmitting the adjust command to the first electronic device for adjusting the second partial image to combine with the first partial image to match the full image.

2. The electronic device according to claim 1, further comprising:
a receiver for receiving a plurality of channel signals; and
a channel selector for selecting the video signal from the plurality of channel signals in accordance with a selection signal.

3. The electronic device according to claim 2, wherein the first electronic device includes a first receiver for receiving the plurality of channel signals and a first channel selector for selecting the video signal from the plurality of channel signals in accordance with the selection signal, wherein the transmitting module transmitting the selection signal to the first electronic device as the adjust command.

4. The electronic device according to claim 3, wherein the plurality of channel signals received by the receiver and the first receiver is a broadcast signal.

5. The electronic device according to claim 1, wherein the control module generates the adjust command in accordance with a directional symbol, which is printed on an outer surface of the electronic device and by which an extending orientation of the electronic device is determined so as to generate the adjust command.

6. The electronic device according to claim 1, wherein the control module generates the adjust command in accordance with a directional symbol which is displayed on the display screen and by which an extending orientation of the electronic device is determined so as to generate the adjust command.

7. The electronic device according to claim 1, further comprising a touch panel that enables a user to touch in order to generate the adjust command.

8. The electronic device according to claim 1, wherein the control module further comprising:
a direction sensor for determining an orientation of the first partial image; and
an image rotating module for generating the adjust command for rotating the second partial image when the orientation of the first partial image being different to an orientation of the second partial image.

9. The electronic device according to claim 8, wherein the direction sensor is a gravitational sensor.

10. The electronic device according to claim 8, wherein the direction sensor is a geomagnetic direction sensor.

11. The electronic device according to claim 8, wherein the direction sensor further comprises:
a photographing device for catching a specific pattern after shooting an object; and
a determining module for determining the orientation of the electronic device after comparing the specific pattern with a pre-stored sample pattern.

12. The electronic device according to claim 11, wherein the first electronic device further comprises:
a first photographing device for photographing the pre-stored sample pattern.

13. A method for displaying a full image of a video signal by an electronic device and a first electronic device, the method comprising the steps:
(i) the electronic device displaying a first partial image of the full image;
(ii) the first electronic device displaying a second partial image of the full image;
(iii) generating an adjust command; and
(iv) transmitting the adjust command to the first electronic device for adjusting the second partial image to combine with the first partial image to match the full image.

14. The method according to claim 14, further comprising the steps:
the electronic device and the first electronic device receiving a plurality of channel signals; and
selecting the video signal from the plurality of channel signals in accordance with a selection signal of the electronic device, the selection signal being the adjust command.

15. The method according to claim 14, wherein the electronic device displays a directional symbol on the first partial image for determining and generating the adjust command.

16. The method according to claim 13, further comprising:
putting the electronic device next to the first electronic device.

17. The method according to claim 13, further comprising:
the electronic device storing a first pattern which photographed by the first electronic device;
the electronic device storing a second pattern which photographed by the electronic device; and
generating the adjust command for rotating the second partial image when an orientation of the first pattern being different to an orientation of the second pattern.
